(19) United States
(12) Patent Application Publication
(10) Pub. No.: US 2015/0096119 A1
(43) Pub. Date: Apr. 9, 2015

(54) PATIENT LIFT SWIVEL

(71) Applicants: Bruce Boyle, Clearwater, FL (US); James McElroy, Clearwater, FL (US); Durand Moon, Clearwater, FL (US)

(72) Inventors: Bruce Boyle, Clearwater, FL (US); James McElroy, Clearwater, FL (US); Durand Moon, Clearwater, FL (US)

(73) Assignee: Superior Technology Solutions, Clearwater, FL (US)

(21) Appl. No.: 14/048,032

(22) Filed: Oct. 7, 2013

(51) Int. Cl. A61G 7/10

(52) U.S. Cl. CPC A61G 7/1046; A61G 7/1017
USPC 5/87.1

(57) ABSTRACT

In some implementations, a patient lift has a portion above the base wheels that is rotatably connected to another member of the patient lift.

### FIELD

This disclosure relates to patient lifts.

### BACKGROUND

Patient lifts are fixed in all structural members, other than swivel caster wheels at the base, such as patient-lifting-device 1200 in FIG. 12 of U.S. Pat. No. 8,310,179.

### BRIEF DESCRIPTION

In one aspect, a patient lift has a portion above the base wheels that is rotatably connected to another member of the patient lift.

In another aspect, an apparatus to move a patient that includes a plurality of wheels, a first support-post fixedly attached to the wheels, the first support-post being indirectly fixedly attached to the wheels, a swivel mechanism having two ends, a first end of the two ends being fixedly attached to the first support-post, the first end of the two ends of the swivel mechanism being indirectly fixedly attached to the first support-post, a large end cap being fixedly attached to a second end of the two ends, another wheel fixedly attached to the large end cap, and a patient lift gantry attached to the large end cap.

In yet another aspect, an apparatus to move a patient includes a plurality of wheels, a first support-post fixedly attached to the wheels, a swivel mechanism having two ends, a first end of the two ends being fixedly attached to the first support-post, a large end cap being fixedly attached to a second end of the two ends, and a patient lift gantry attached to the large end cap.

In yet a further aspect, an apparatus to move a patient includes a plurality of wheels, a first support-post fixedly attached to the wheels, a swivel mechanism having two ends, a first end of the two ends being fixedly attached to the first support-post, a pivoting member being fixedly attached to a second end of the two ends, and a patient lift gantry attached to the large end cap.

### BRIEF DESCRIPTION OF THE DRAWINGS

FIG. 1 is block diagram of an exploded side view of a patient lift having a swivel mechanism that is located between base wheels and a patient gantry, according to an implementation.

FIG. 2 is block diagram of a top view of the patient lift having the swivel mechanism that is located between base wheels and the patient gantry, according to an implementation.

FIG. 3 is a block diagram of a front view of a top portion of a swivel mechanism, according to an implementation.

FIG. 4 is a block diagram of a side view of a top portion of the swivel mechanism, according to an implementation.

FIG. 5 is a block diagram of a front view of an entire swivel mechanism, according to an implementation.

FIG. 6 is a block diagram of a side view of a top portion of the swivel mechanism, according to an implementation.

FIG. 7 is a block diagram of a top view of the swivel mechanism, according to an implementation.

FIG. 8 is a block diagram of a top view of the swivel mechanism, according to an implementation.

FIG. 9 is a block diagram of a bottom view of the swivel mechanism, according to an implementation.

FIG. 10 is a block diagram of a bearing assembly of the swivel mechanism, according to an implementation.

FIG. 11 is a block diagram of a side view of the top portion of the swivel mechanism, according to an implementation.

FIG. 12 is a block diagram of a top view of the top portion of the swivel mechanism, according to an implementation.

FIG. 13 is a block diagram of a top view of an anchor and a base and plate, according to an implementation.

FIG. 14 is a block diagram of a side view of the anchor and the base and plate, according to an implementation.

FIG. 15 is a block diagram of a side view of a patient lift foot, according to an implementation.

FIG. 16-17 are block diagrams of a support plug, according to an implementation.

FIG. 18-19 are block diagrams of a slider insert, according to an implementation.

FIG. 20-21 are block diagrams of a crank shaft, according to an implementation.

FIG. 22-23 are block diagrams of a crank shaft bushing, according to an implementation.

FIG. 24-26 are block diagrams of a support base, according to an implementation.

FIG. 27-28 are block diagrams of a screw shaft, according to an implementation.

FIG. 29-30 are block diagrams of a lift screw, according to an implementation.

FIG. 31-32 are block diagrams of a top view of a lift screw anti-vibration apparatus, according to an implementation.

FIG. 33-34 are block diagrams of a lift nut, according to an implementation.

FIG. 35-36 are block diagrams of a lift nut HSG, according to an implementation.

FIG. 37-40 are block diagrams of a lift slider HSG, according to an implementation.

FIG. 41-42 are block diagrams of a crank adapter, according to an implementation.

FIG. 43-44 are block diagrams of a crank shaft lock cover, according to an implementation.

FIG. 45-49 are block diagrams of a top view of a rail corner support, according to an implementation.

FIG. 50-52 are block diagrams of a top view of a gusset, according to an implementation.

FIG. 53-54 are block diagrams of a trolley shaft, according to an implementation.

FIG. 55-58 are block diagrams of a pin assembly, according to an implementation.

FIG. 59 is an electrical schematic diagram of a patient lift control apparatus to control a patient lift, according to an implementation.

FIG. 60 is a flowchart of a method to operate a patient with an articulating section, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into four sections. In the first section, a system level overview is described. In the second section, apparatus of implementations are described. In the third section, implementations of methods are described. Finally, in the fourth section, a conclusion of the detailed description is provided.

### System Level Overview

The system level overview of the operation of an implementation is described in this section of the detailed description.

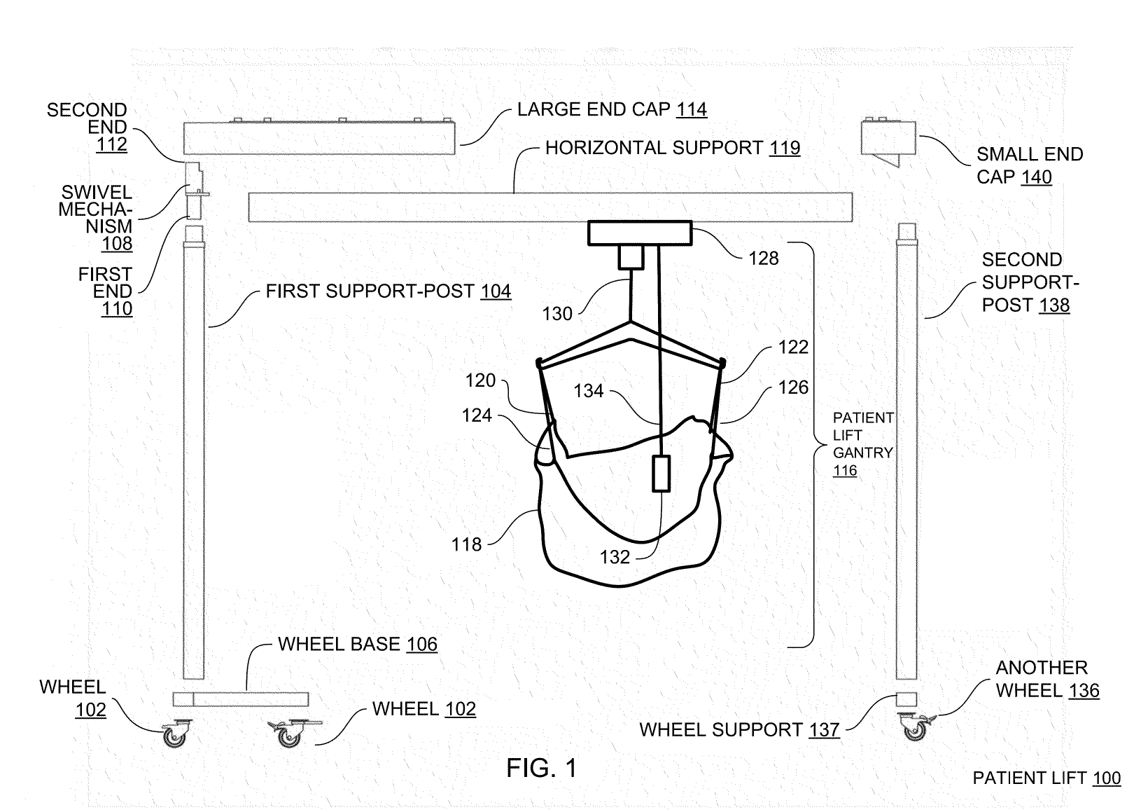

FIG. 1 is block diagram of an exploded side view of a patient lift 100 having a swivel mechanism that is located between base wheels and a patient gantry, according to an implementation. The patient lift 100 is an apparatus to move a patient. The patient lift 100 includes a plurality of wheels 102.

The patient lift 100 also includes a first support-post 104 that is fixedly attached to the wheels 102. In the example shown in FIG. 1, the first support-post 104 is indirectly fixedly attached to the wheels 102 through another wheel base 106.

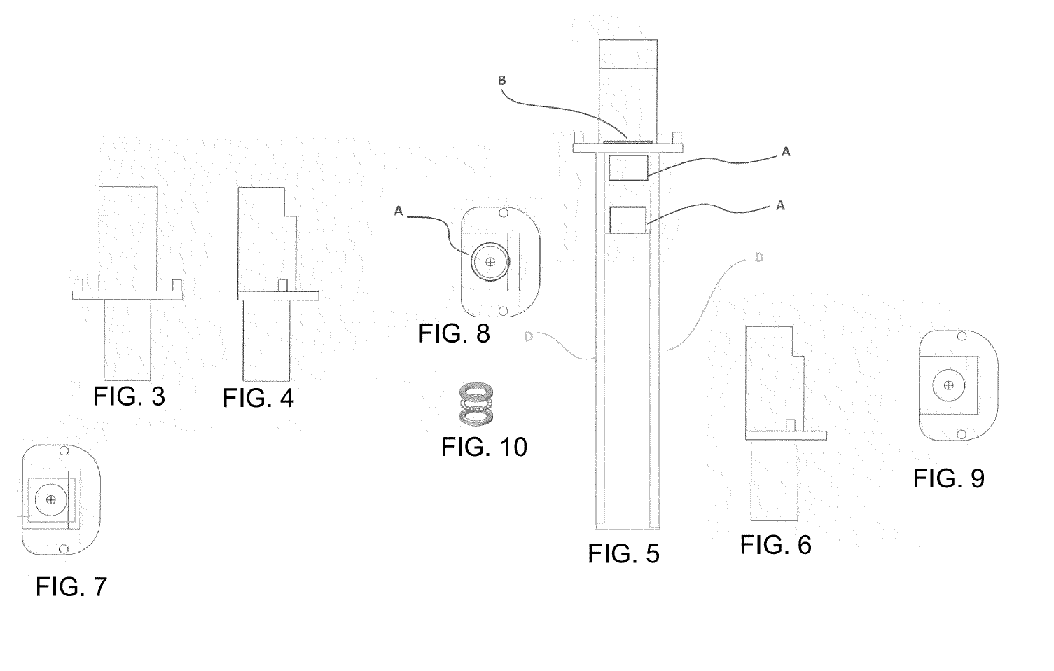

The patient lift 100 also includes a swivel mechanism 108 having two ends 110 and 112. A first end 110 of the two ends 110 and 112 being fixedly attached to the first support-post 104. Different implementations of the swivel mechanism 108 are shown in FIG. 3-10.

The patient lift 100 also includes a large end cap 114 being fixedly attached to a second end 112 of the two ends 110 and 112.

The patient lift 100 also includes a patient lift gantry 116 that is attached to the large end cap 116.

In the implementation shown in FIG. 1, the patient lift gantry 116 includes a seat or hammock 118 is attached to the horizontal support 119 via lines 120, 122, 124 and 126, although other implementations of the seat or hammock 118 are well-known. An electric or hydraulic control box 128 is slidably attached to the horizontal support 119 through a rail (not shown) and the lines 120, 122, 124 and 126 are attached to the control box 128 through a line 130. The control box 128 causes the line 130 to be extended or retracted. A patient is placed in the seat or hammock 118 for movement. As the line 130 is extended, the hammock or seat 118 is lowered downward, thus causing the patient in the hammock or seat 118 to move downward. As the line 130 is retracted, the seat or hammock 118 is moved upward, thus causing the patient in the hammock or seat 118 to move upwards. In addition the control box 128 is operable to move horizontally along the horizontal support 119 on the horizontal support 119.

In some implementations, the control box 128 includes various apparatus and systems described in this application that provide control of the patient lift gantry 100 from a keyboard data receiver. In some implementations, patient lift 100 includes a hand-held keypad controller 132 that includes buttons for up, down, forward, backward and stop 132 in the control box 128 via a line 134, the hand-held keypad controller 132 providing signals that direct movement of the line 130 and movement of the control box 128 along the horizontal support 119. In some implementations, control initiated from the hand-held keypad controller 132 overrides control initiated from other input means.

Some implementations of patient lift 100 include a charging unit (not shown) in the horizontal support 119 and/or the control box 128 to provide power for recharging a battery. The battery can be mounted either in the control box 128 or the horizontal support 119. The charging unit is electrically coupled to a power cord having male prongs on the other end from the charging unit that are suitable to plug into a standard residential electrical wall outlet female receptacle.

The patient lift 100 includes another wheel 136 that is indirectly and fixedly attached to a second support-post 138 through a wheel support 137 and the large end cap 114. The wheel 136 is fixedly attached to the large end cap 114 through the horizontal support 119 and a small end cap 140 and the second support-post 138 and through a wheel support 137 that is attached to other wheel 136. The first support-post 104, wheel base 106, large end cap 114, the horizontal support 119, second support-post 136 and the small end cap 140 are substantially inflexible. in order to support at least the weight of most humans. In some implementations, the first support-post 104 is directly fixedly attached to the wheels 102 in the absence of the wheel base 106. In some implementations, the large end cap being directly fixedly attached to the second end of the two ends. In some implementation, the large end cap 114 is indirectly fixedly attached to the second end 112 of the two ends of the swivel mechanism 108. In some implementation, the first end 110 of the two ends of the swivel mechanism 108 is directly and fixedly attached to the first support-post 104. In some implementation, the first end 110 of the two ends of the swivel mechanism 108 is indirectly and fixedly attached to the first support-post 104.

In some implementation, the five components of the large end cap 114, horizontal support 119, the small end cap 140, the second support-post 138 and the wheel support 137 are manufactured as fewer than five components; in some case, as few as one component. These components whether manufactured as 1, 2, 3, 4 or 5 components, can be referred to as a pivoting member.

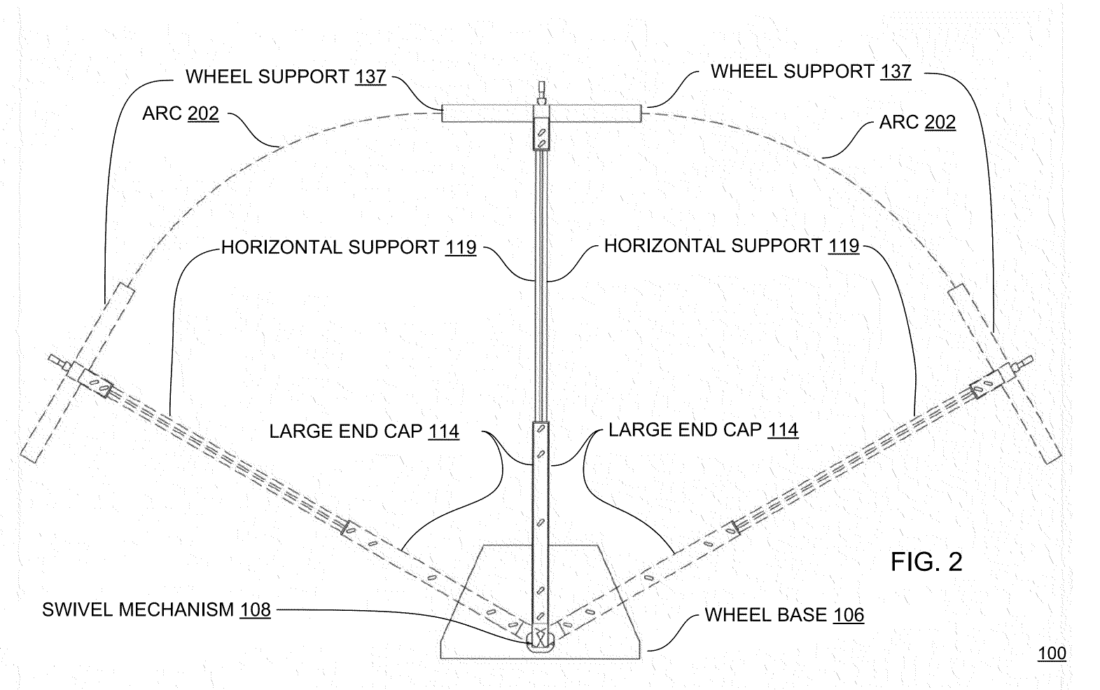

FIG. 2 is block diagram of a top view of the patient lift 100 having the swivel mechanism that is located between base wheels and the patient gantry. The patient lift 100 shown in FIG. 1 includes only one large end cap 114 and only one horizontal support 119 that rotate 180 degrees around the swivel mechanism 108.

The horizontal support 119 telescopes in relation to the large end cap 114. Internal structures inside the horizontal support 119 allow the horizontal support 119 to telescope to adjust to fit over a bed or in an elevator. The internal structures inside the horizontal support 119 are not visible on the outside, but the internal structures are serviceable. Timkin® screw bearings can be implemented in the internal structures. The patient life 110 does not require a pin to set the height of the first support-post 104. The first support-post 104 automatically locks in place once rotating halts. The patient lift 100 does not move or retract on its own. A 90 degree gear is attached and threaded through a two inch nut on a screw to stabilize the patient lift 100. The threads on the nut bear down and do not let the screw turn.

While the system 100 in FIGS. 1 and 2 is not limited to any wheel(s) 102, first support-post 104, wheel base 106, swivel mechanism 108 having a first and second end 110 and 112, large end cap 114, the horizontal support 119, lines 120, 122, 124 and 126, electric or hydraulic control box 128, line 130, a hand-held keypad controller 132, line 134, wheel 136, second support-post 138 and a small end cap 140, for sake of clarity, simplified wheel(s) 102, first support-post 104, wheel base 106, swivel mechanism 108 having the first and second end 110 and 112, large end cap 114, the horizontal support 119, lines 120, 122, 124 and 126, electric or hydraulic control box 128, line 130, hand-held keypad controller 132, line 134, wheel 136, second support-post 138 and small end cap 140 are described.

### Apparatus Implementations

In the previous section, a system level overview of the operation of an implementation was described. In this section, the particular apparatus of such an implementation are described by reference to a series of diagrams.

Swivel mechanism 300 in FIG. 3-10 is one example of swivel mechanism 108 in FIG. 1.

FIG. 3 is a block diagram of a front view of a top portion of a swivel mechanism 300, according to an implementation. Some implementations of swivel mechanism 108 include a bearing, 2 bushings, and a steel pin in the center of the swivel mechanism 108.

FIG. 4 is a block diagram of a side view of a top portion of the swivel mechanism, according to an implementation.

FIG. 5 is a block diagram of a front view of an entire swivel mechanism, according to an implementation.

FIG. 6 is a block diagram of a side view of a top portion of the swivel mechanism, according to an implementation.

FIG. 7 is a block diagram of a top view of the swivel mechanism, according to an implementation.

FIG. 8 is a block diagram of a top view of the swivel mechanism, according to an implementation.

FIG. 9 is a block diagram of a bottom view of the swivel mechanism, according to an implementation.

FIG. 10 is a block diagram of a bearing assembly of the swivel mechanism, according to an implementation.

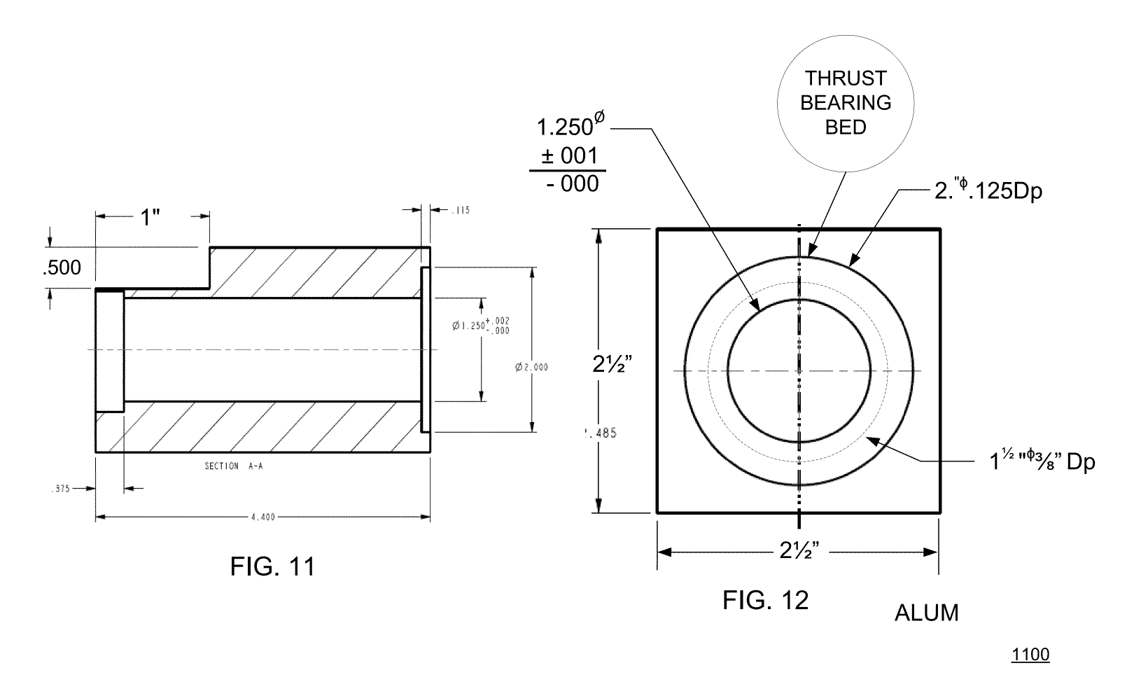

FIG. 11 is a block diagram of a side view of the top portion of the swivel mechanism, according to an implementation.

FIG. 12 is a block diagram of a top view of the top portion of the swivel mechanism, according to an implementation.

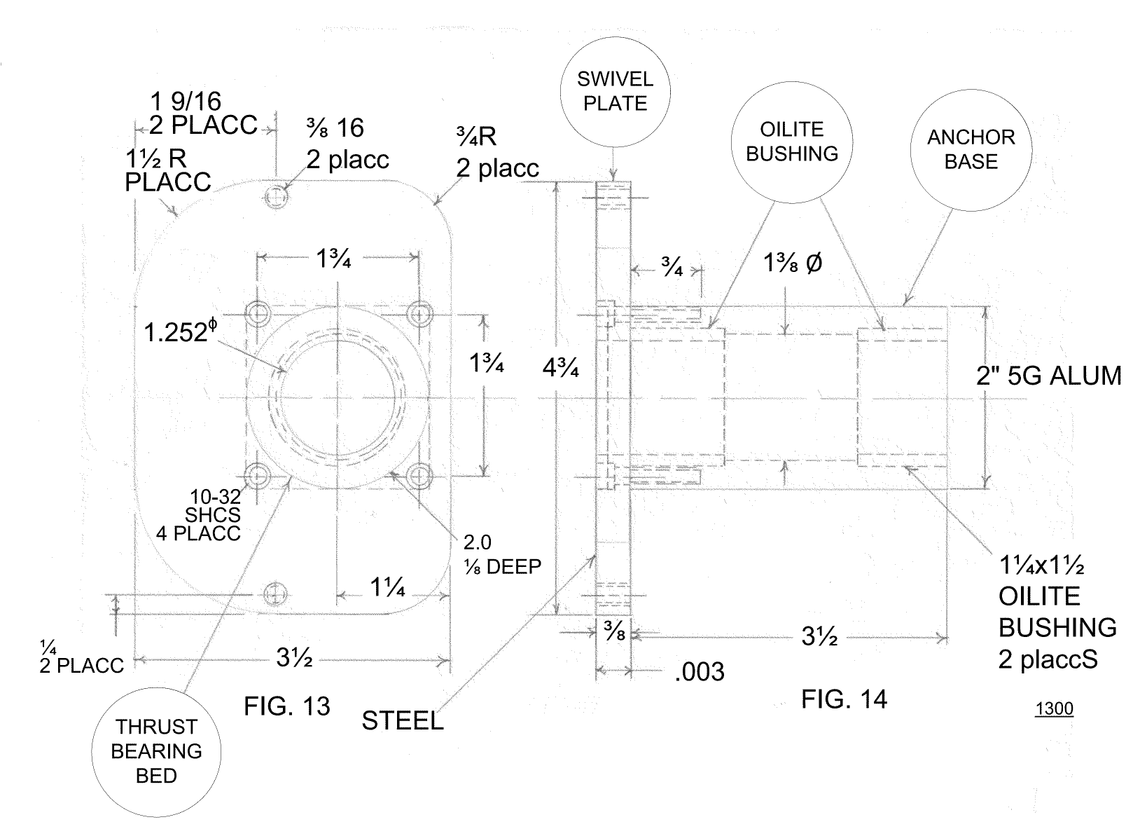

FIG. 13 is a block diagram of a top view of an anchor and a base and plate, according to an implementation, which is located in the bottom portion of the swivel mechanism 300 in FIG. 3.

FIG. 14 is a block diagram of a side view of the anchor and the base and plate, according to an implementation, which is located in the bottom portion of the swivel mechanism 300 in FIG. 3.

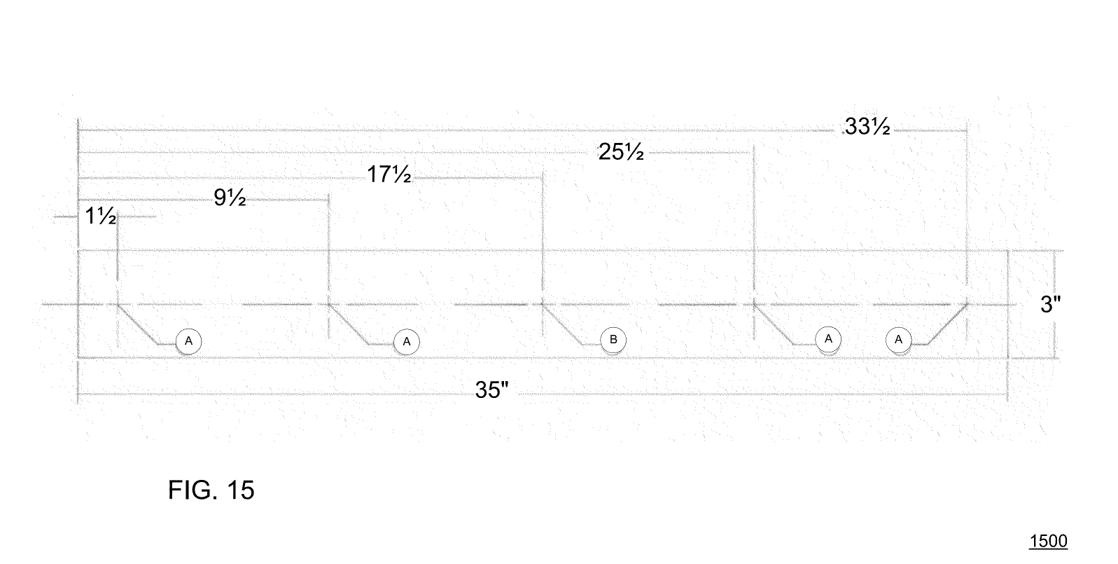

FIG. 15 is a block diagram of a side view of a patient lift foot, according to an implementation, which is located in the wheel support 137 in FIG. 1.

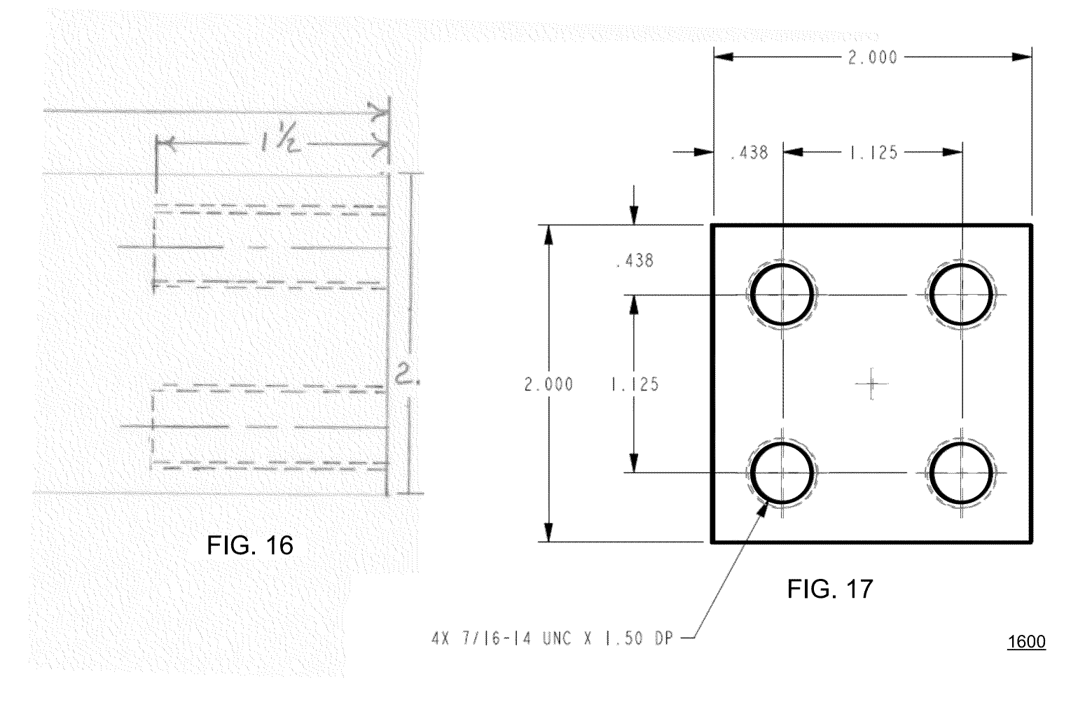

FIG. 16 is a block diagram of a side view of a support plug, according to an implementation, which is located in the second support-post 138 in FIG. 1.

FIG. 17 is a block diagram of a top view of the support plug, according to an implementation, which is located in the second support-post 138 in FIG. 1.

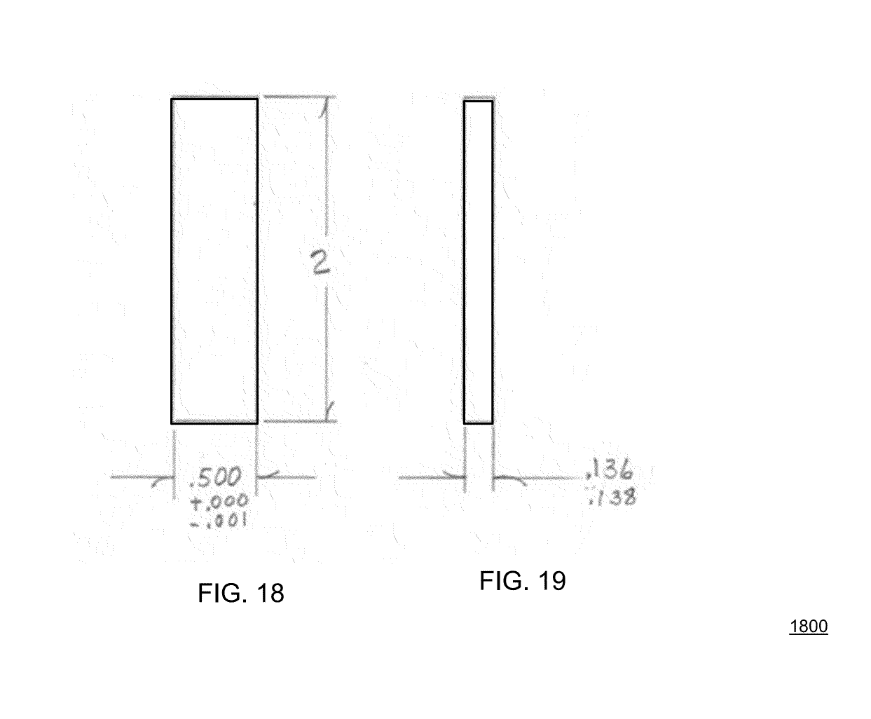

FIG. 18 is a block diagram of a side view of a slider insert, according to an implementation, which is located in the second support-post 138 in FIG. 1.

FIG. 19 is a block diagram of a top view of the slider insert, according to an implementation, which is located in the second support-post 138 in FIG. 1.

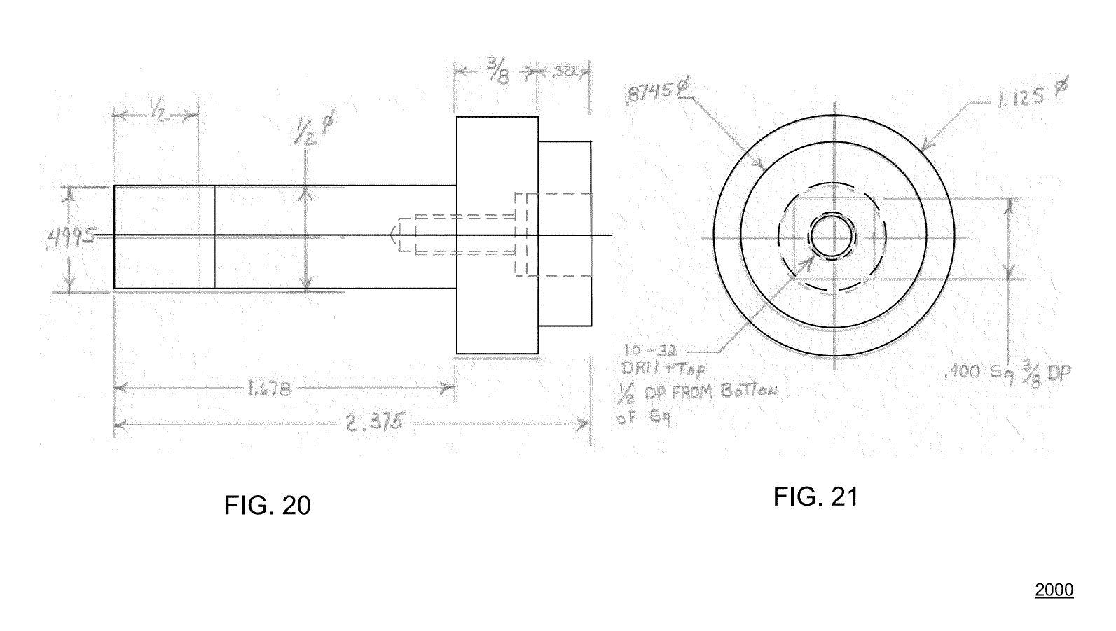

FIG. 20 is a block diagram of a side view of a crank shaft, according to an implementation, which is located in the second support-post 138 in FIG. 1.

FIG. 21 is a block diagram of a top view of the crank shaft, according to an implementation, which is located in the second support-post 138 in FIG. 1.

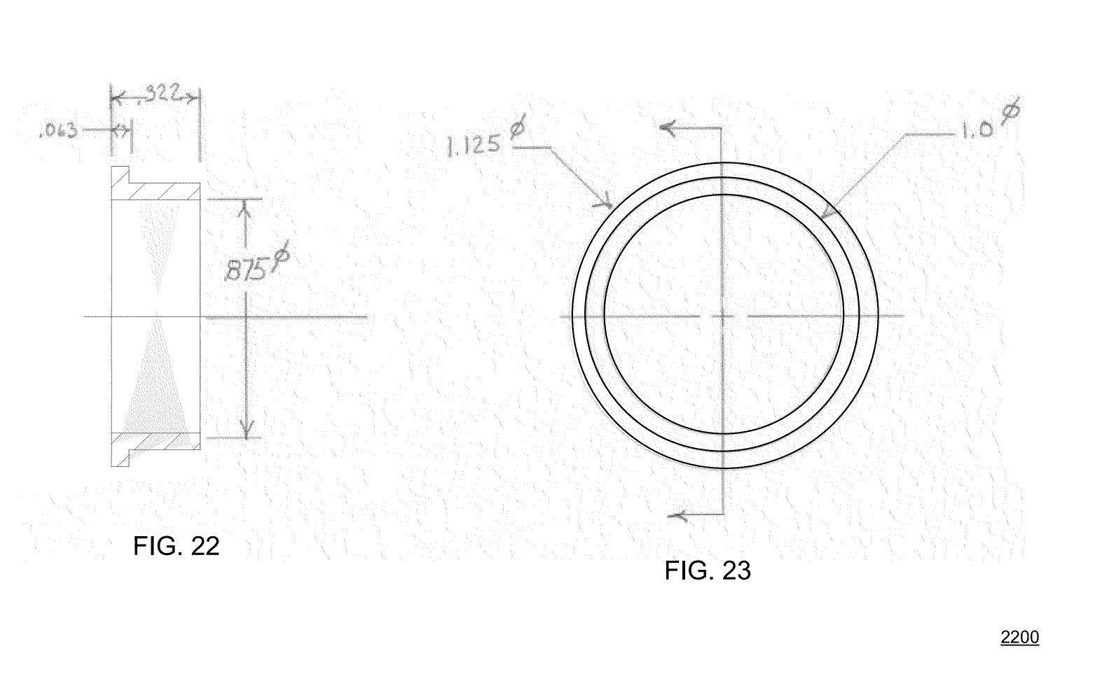

FIG. 22 is a block diagram of a side view of a crank shaft bushing, according to an implementation, which is located in the second support-post 138 in FIG. 1.

FIG. 23 is a block diagram of a top view of the crank shaft bushing, according to an implementation, which is located in the second support-post 138 in FIG. 1.

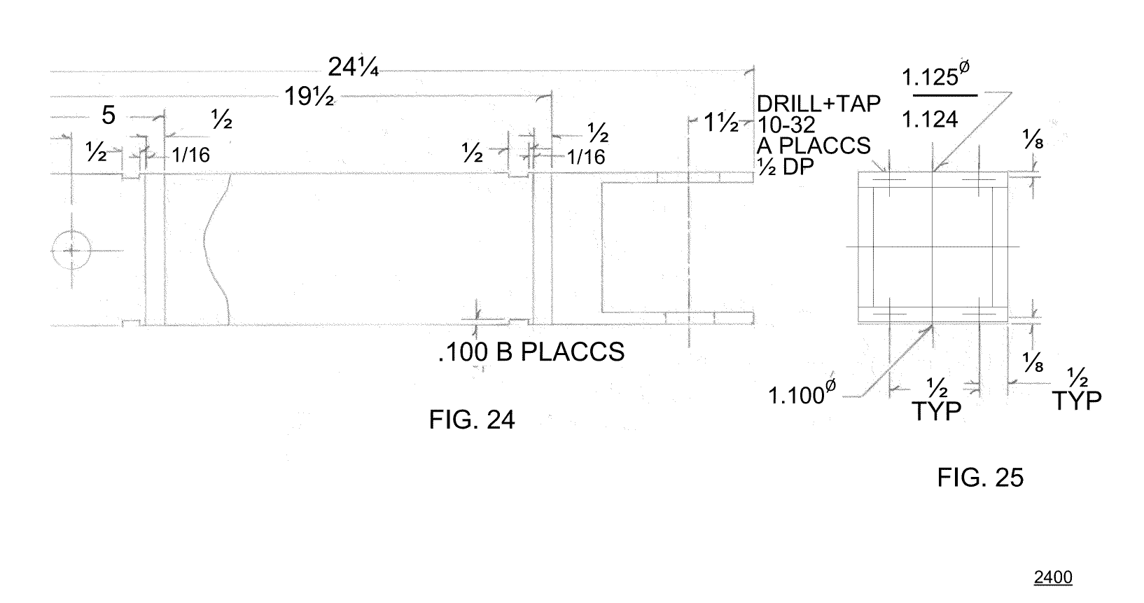

FIG. 24 is a block diagram of a side view of a support base, according to an implementation, which is located in the second support-post 138 in FIG. 1.

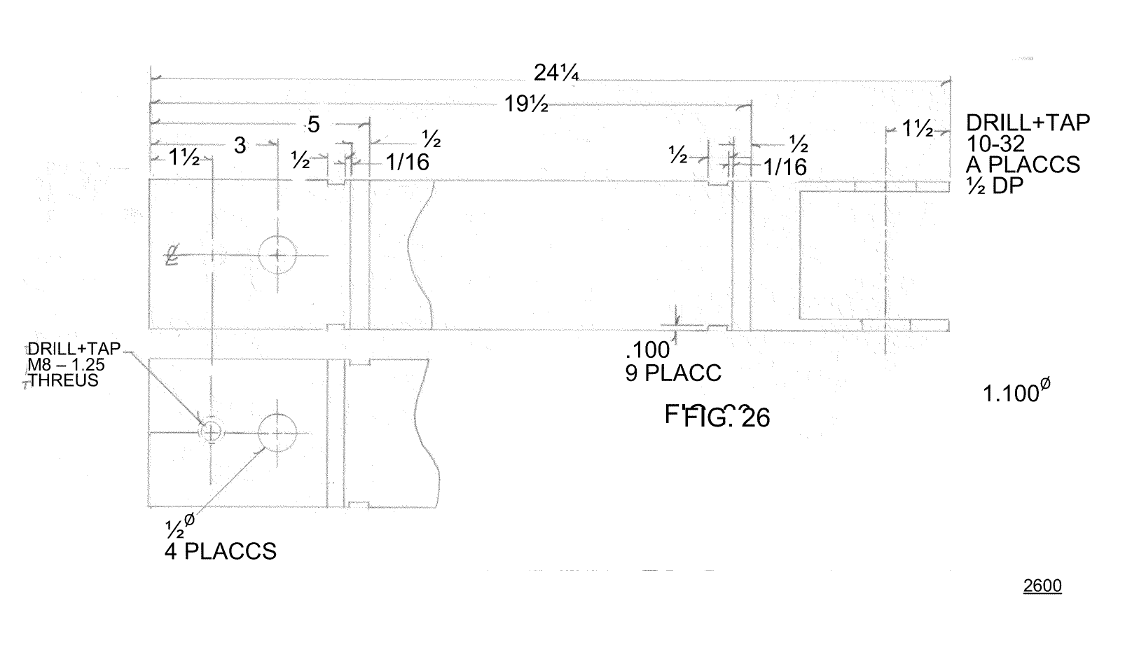

FIG. 25 is a block diagram of a top view of the support, according to an implementation, which is located in the second support-post 138 in FIG. 1.

FIG. 26 is a block diagram of a side view of the support base, according to an implementation, which is located in the second support-post 138 in FIG. 1.

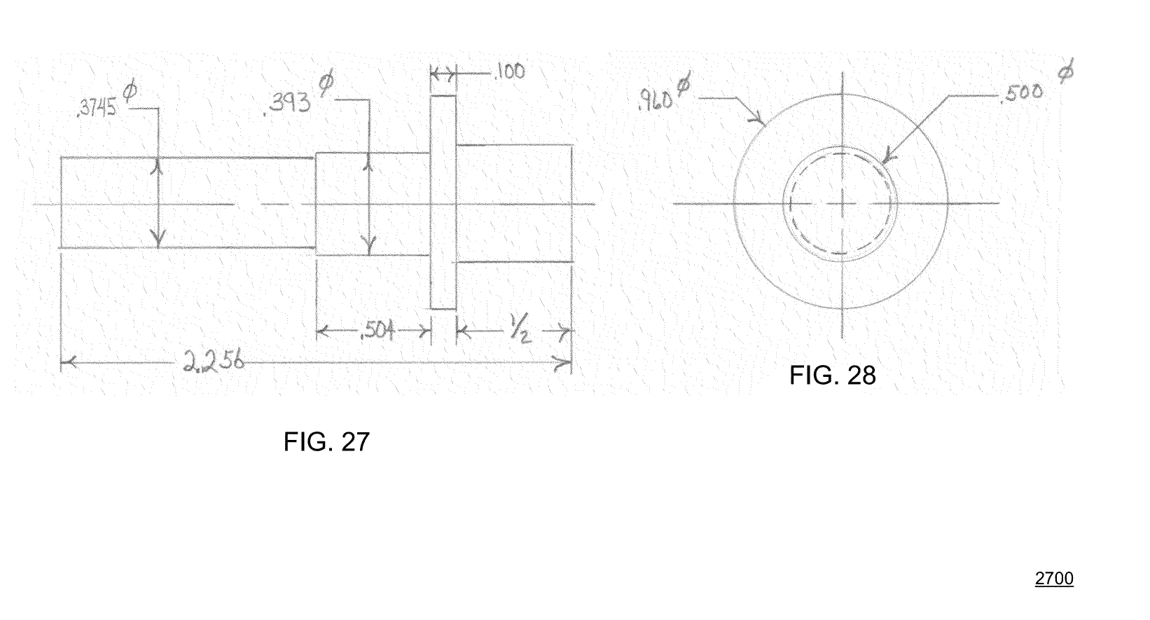

FIG. 27 is a block diagram of a side view of a screw shaft, according to an implementation, which is located in the second support-post 138 in FIG. 1.

FIG. 28 is a block diagram of a top view of the screw shaft, according to an implementation, which is located in the second support-post 138 in FIG. 1.

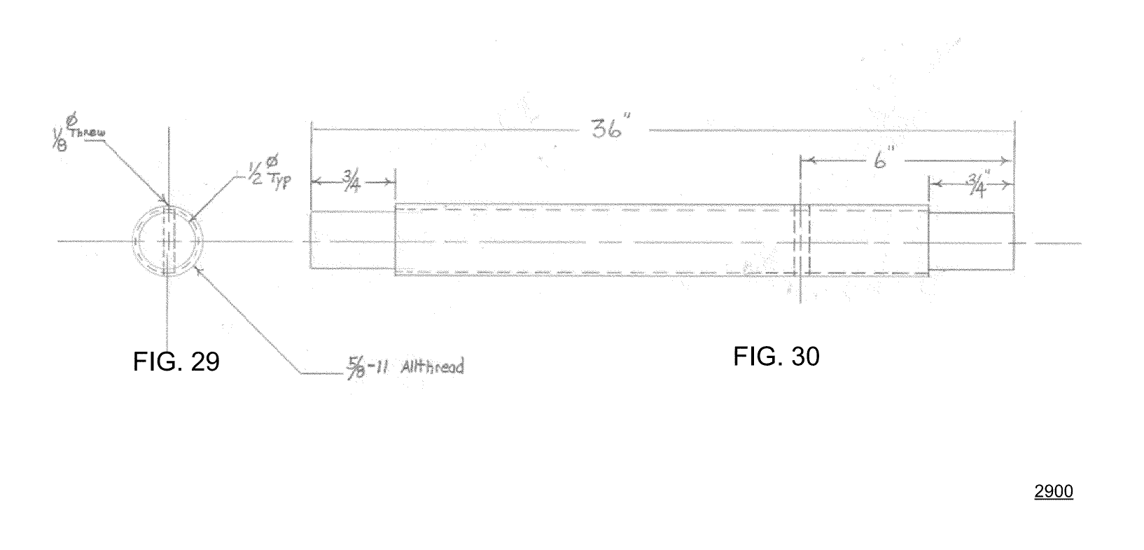

FIG. 29 is a block diagram of a top view of a lift screw, according to an implementation, which is located in the second support-post 138 in FIG. 1.

FIG. 30 is a block diagram of a side view of the lift screw, according to an implementation, which is located in the second support-post 138 in FIG. 1.

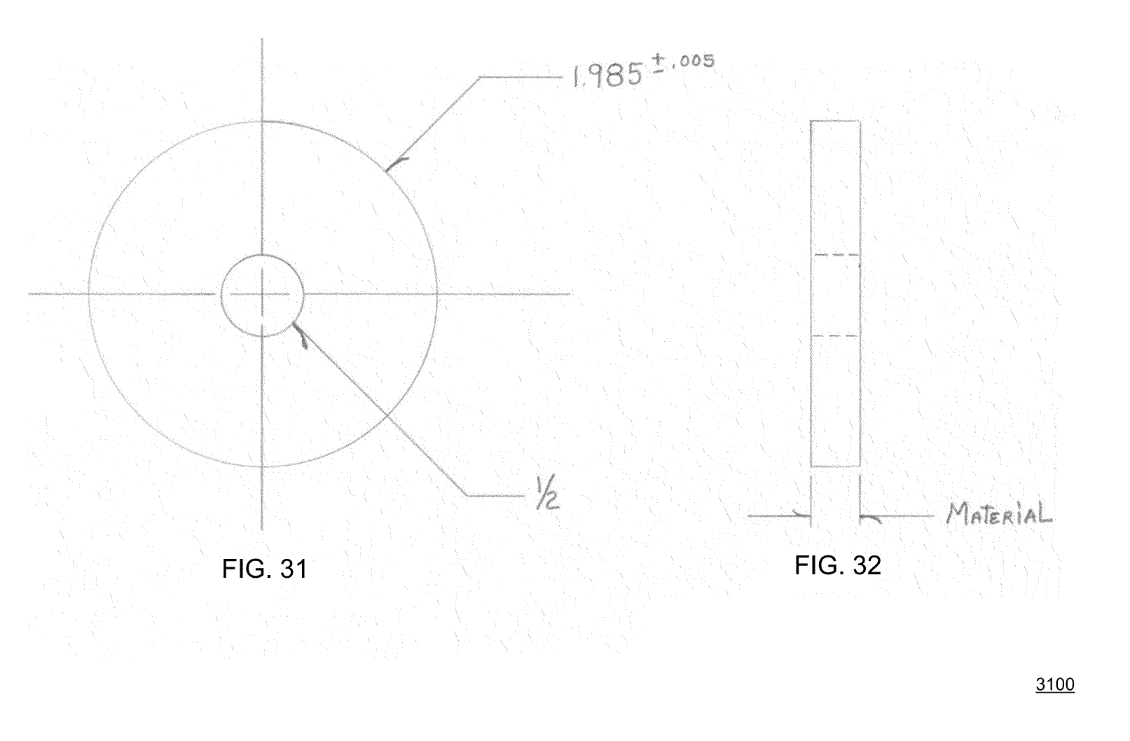

FIG. 31 is a block diagram of a top view of a lift screw anti-vibration apparatus, according to an implementation, which is located in the second support-post 138 in FIG. 1.

FIG. 32 is a block diagram of a side view of the lift screw anti-vibration apparatus, according to an implementation, which is located in the second support-post 138 in FIG. 1.

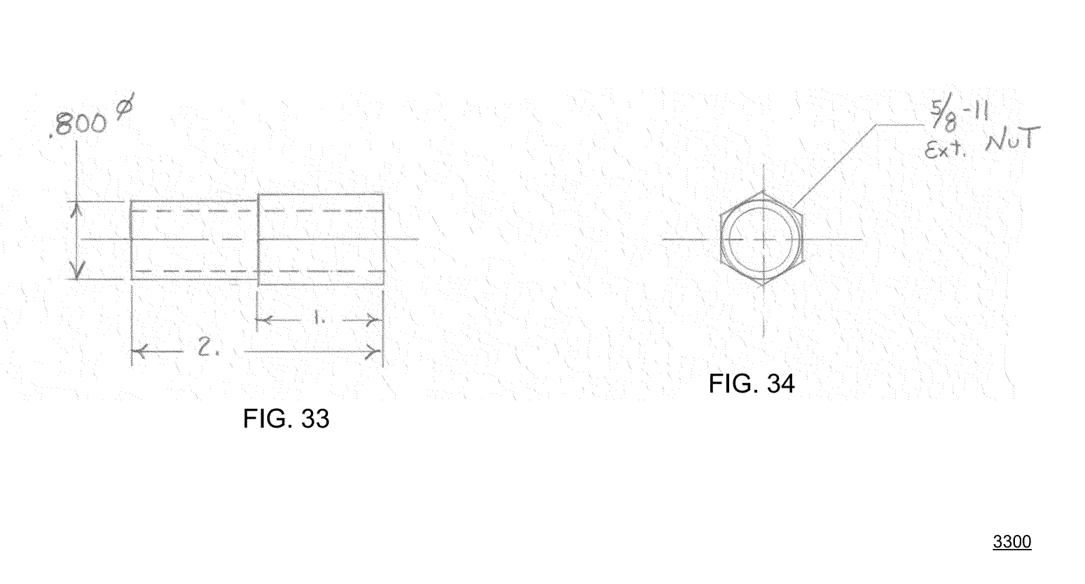

FIG. 33 is a block diagram of a side view of a lift nut, according to an implementation, which is located in the second support-post 138 in FIG. 1.

FIG. 34 is a block diagram of a top view of the lift nut, according to an implementation, which is located in the second support-post 138 in FIG. 1.

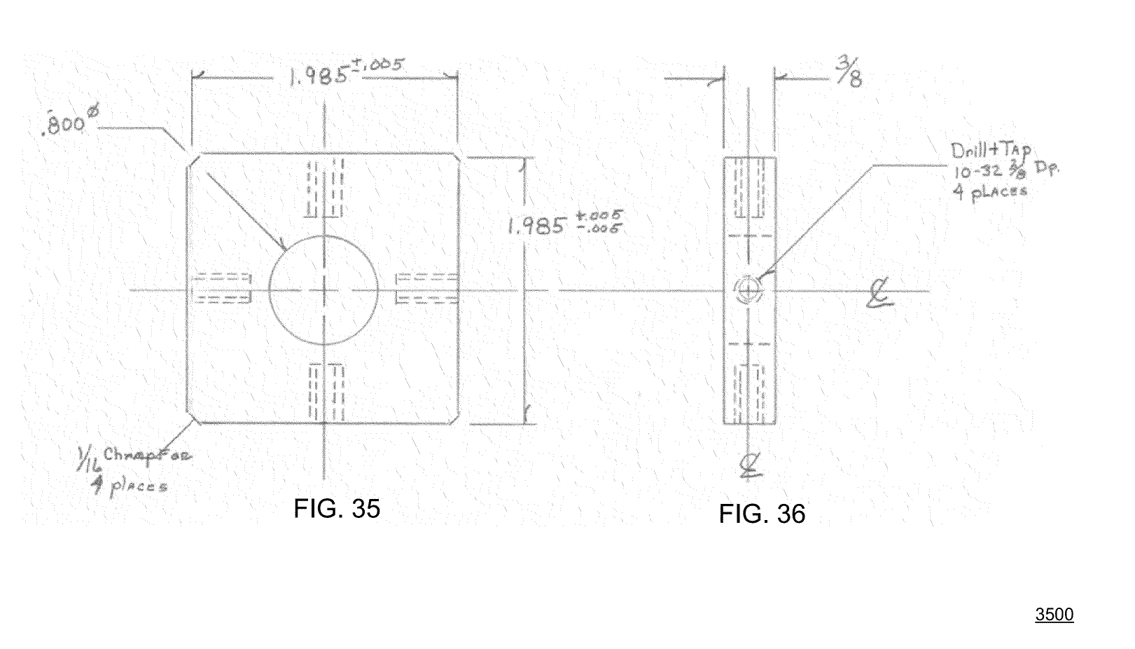

FIG. 35 is a block diagram of a side view of a lift nut HSG, according to an implementation, which is located in the second support-post 138 in FIG. 1.

FIG. 36 is a block diagram of a top view of the lift nut HSG, according to an implementation, which is located in the second support-post 138 in FIG. 1.

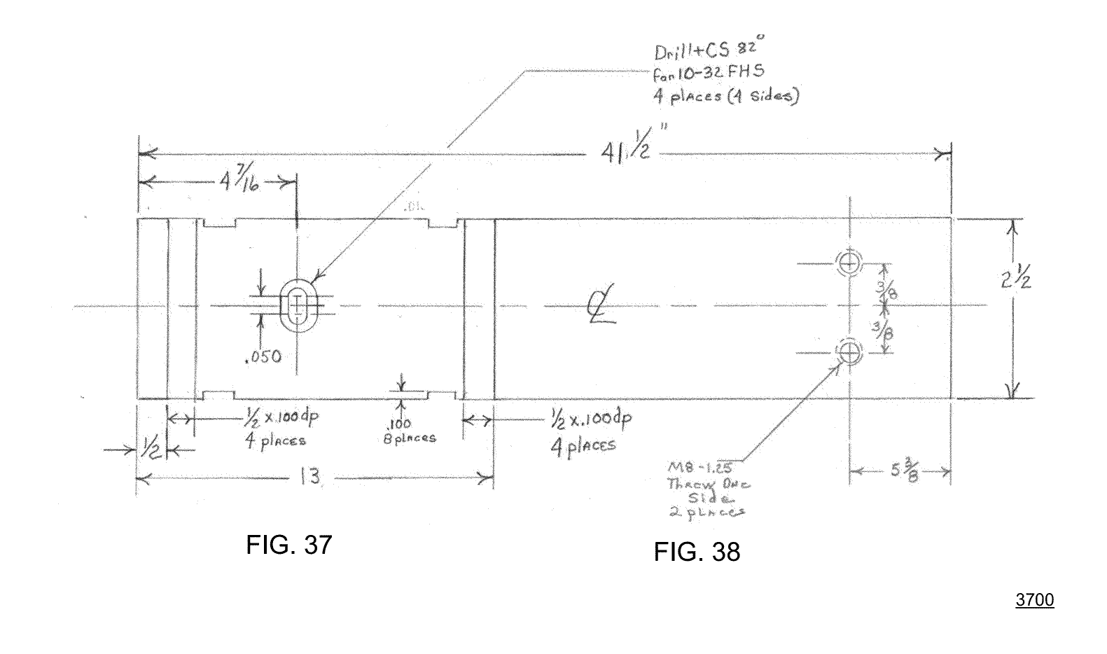

FIG. 37 is a block diagram of a side view of a lift slider HSG, according to an implementation, which is located in the second support-post 138 in FIG. 1.

FIG. 38 is a block diagram of a top view of the lift slider HSG, according to an implementation, which is located in the second support-post 138 in FIG. 1.

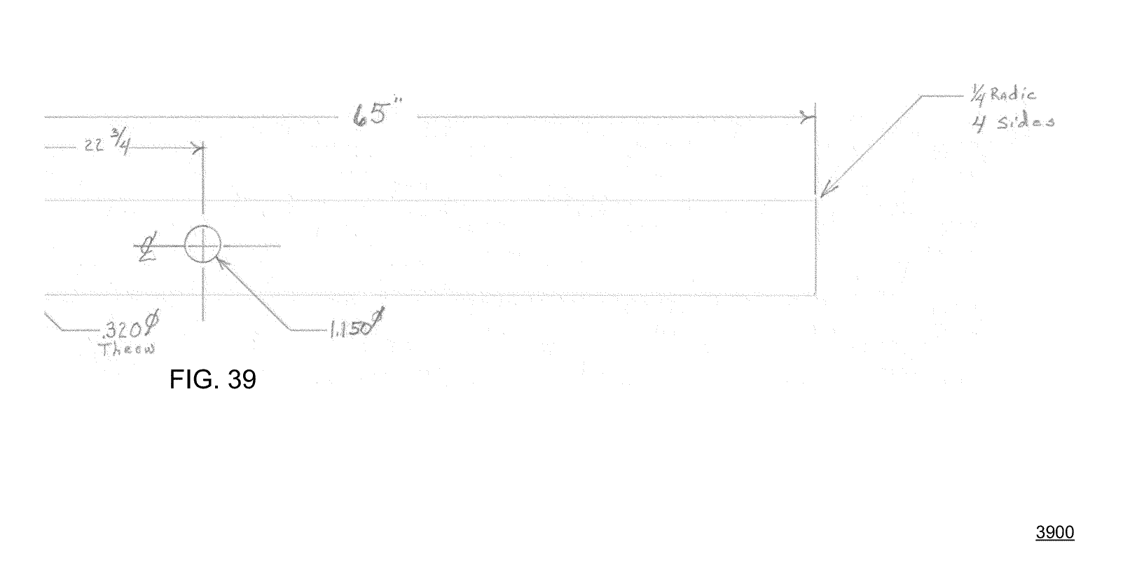

FIG. 39 is a block diagram of a side view of the lift slider HSG, according to an implementation, which is located in the second support-post 138 in FIG. 1.

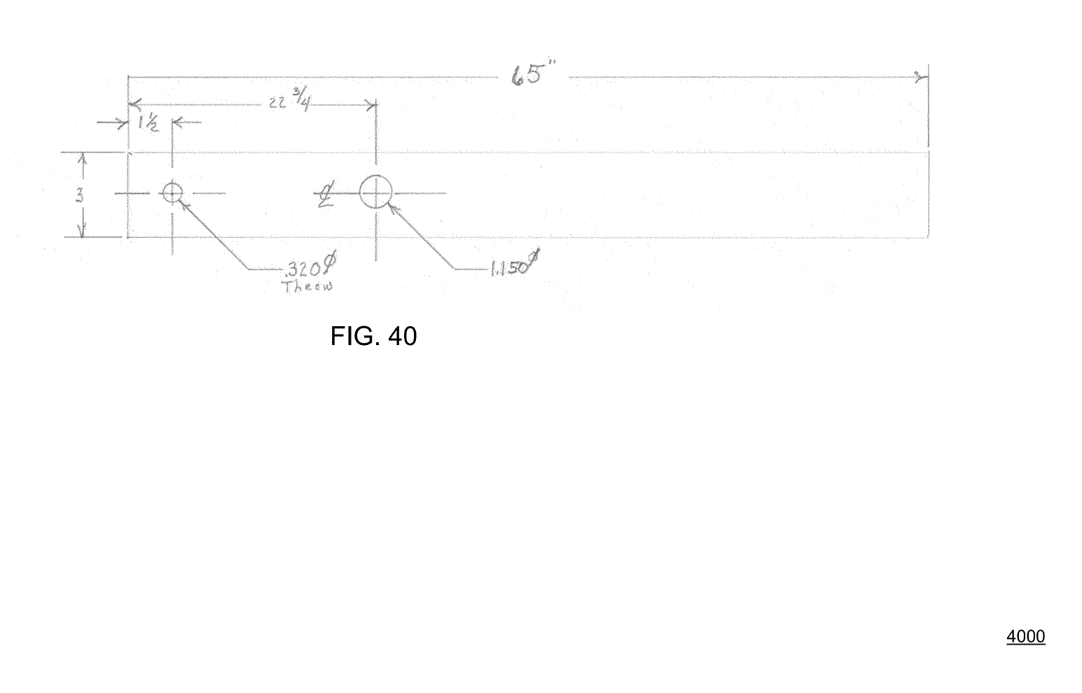

FIG. 40 is a block diagram of a side view of the lift slider HSG, according to an implementation, which is located in the second support-post 138 in FIG. 1.

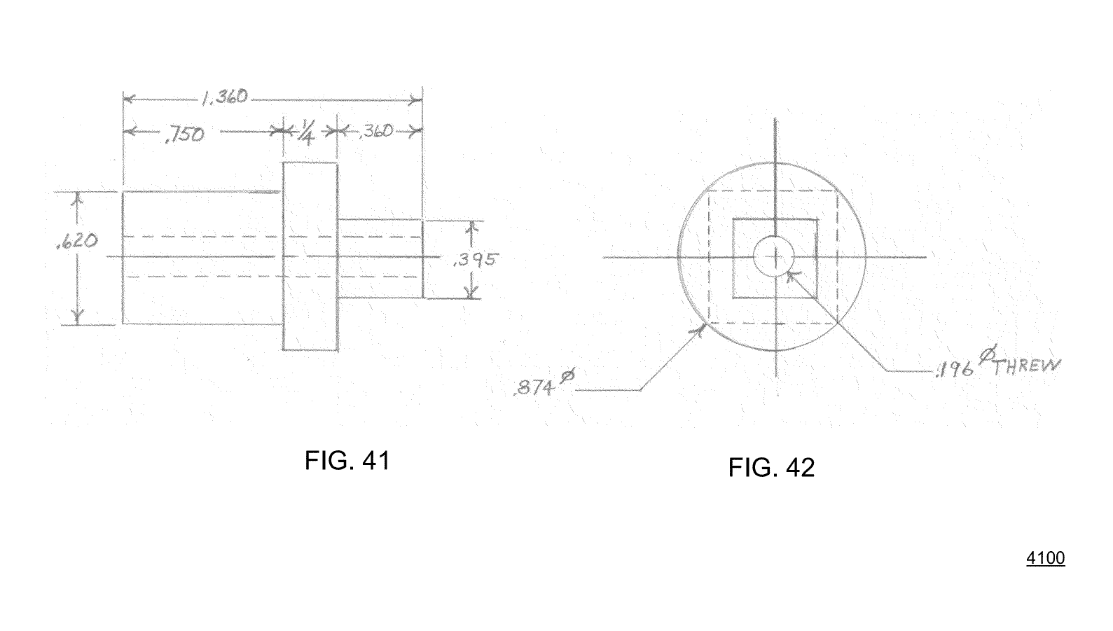

FIG. 41 is a block diagram of a side view of a crank adapter, according to an implementation, which is located in the second support-post 138 in FIG. 1.

FIG. 42 is a block diagram of a top view of a crank adapter, according to an implementation, which is located in the second support-post 138 in FIG. 1.

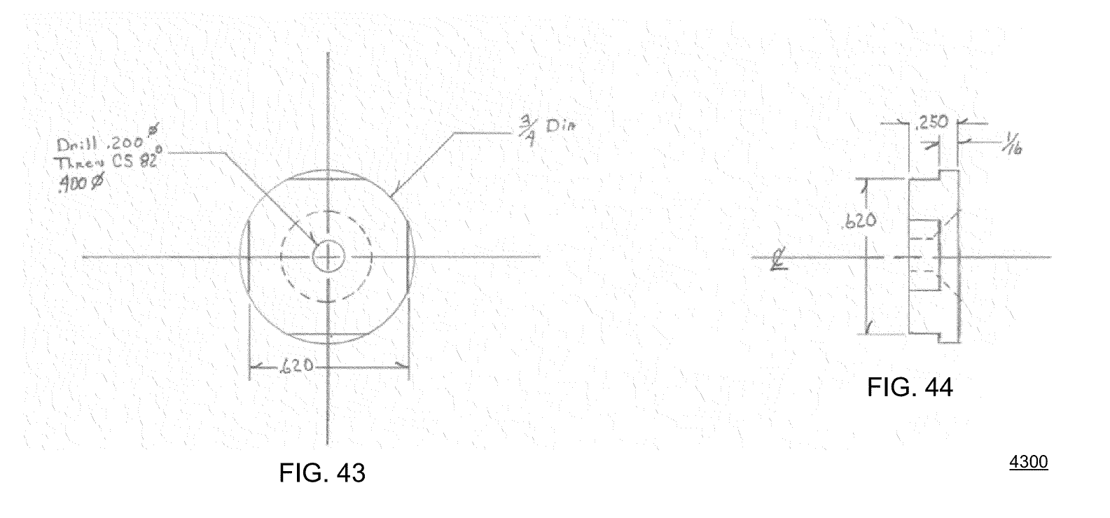

FIG. 43 is a block diagram of a top view of a crank shaft lock cover, according to an implementation, which is located in the second support-post 138 in FIG. 1.

FIG. 44 is a block diagram of a side view of the crank shaft lock cover, according to an implementation, which is located in the second support-post 138 in FIG. 1.

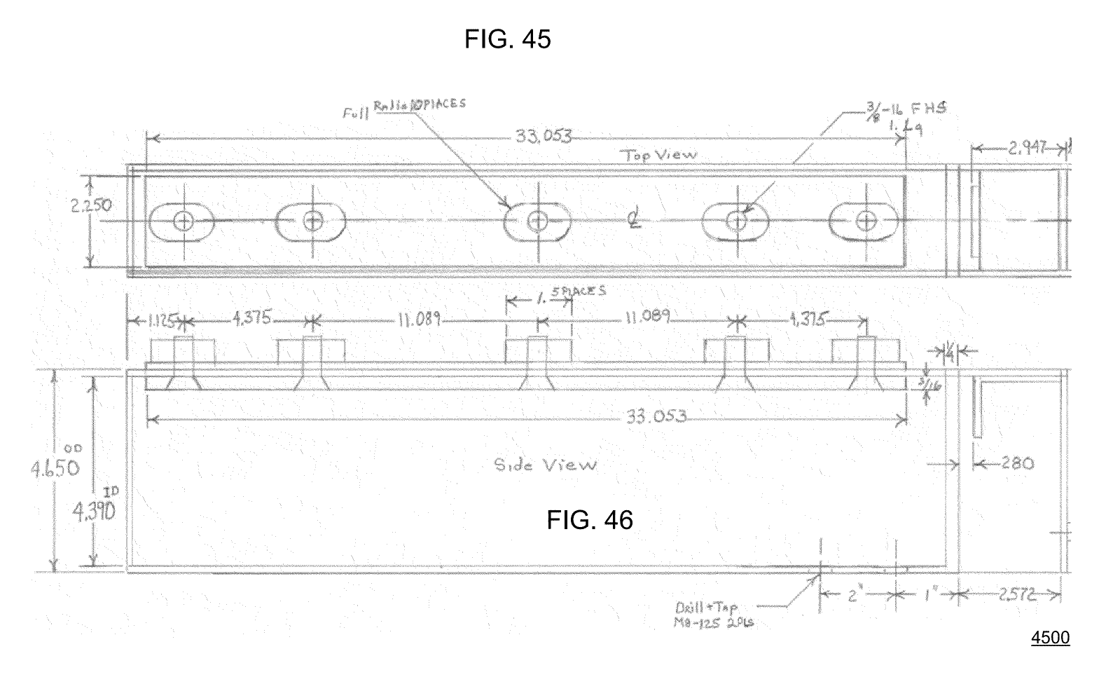

FIG. 45 is a block diagram of a top view of a rail corner support, according to an implementation, which is located in the second support-post 138 in FIG. 1.

FIG. 46 is a block diagram of a side view of the corner support, according to an implementation, which is located in the large end cap 114 in FIG. 1.

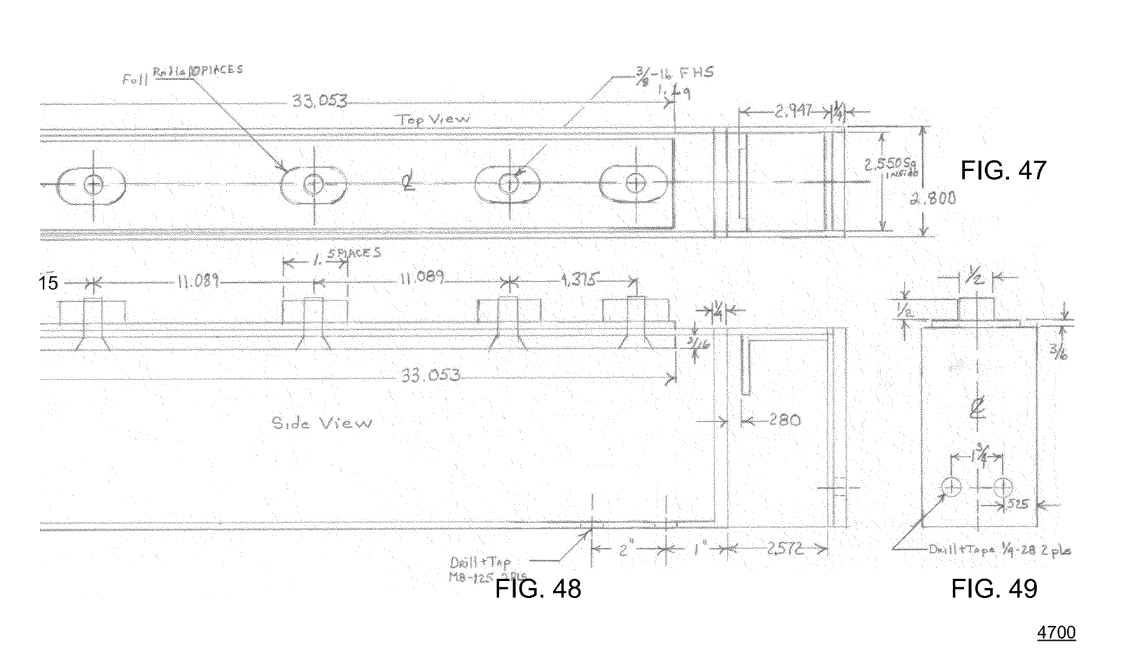

FIG. 47 is a block diagram of a top view of a rail corner support, according to an implementation, which is located in the large end cap 114 in FIG. 1.

FIG. 48 is a block diagram of a side view of the rail corner support, according to an implementation, which is located in the large end cap 114 in FIG. 1.

FIG. 49 is a block diagram of a side view of the rail corner support, according to an implementation, which is located in the large end cap 114 in FIG. 1.

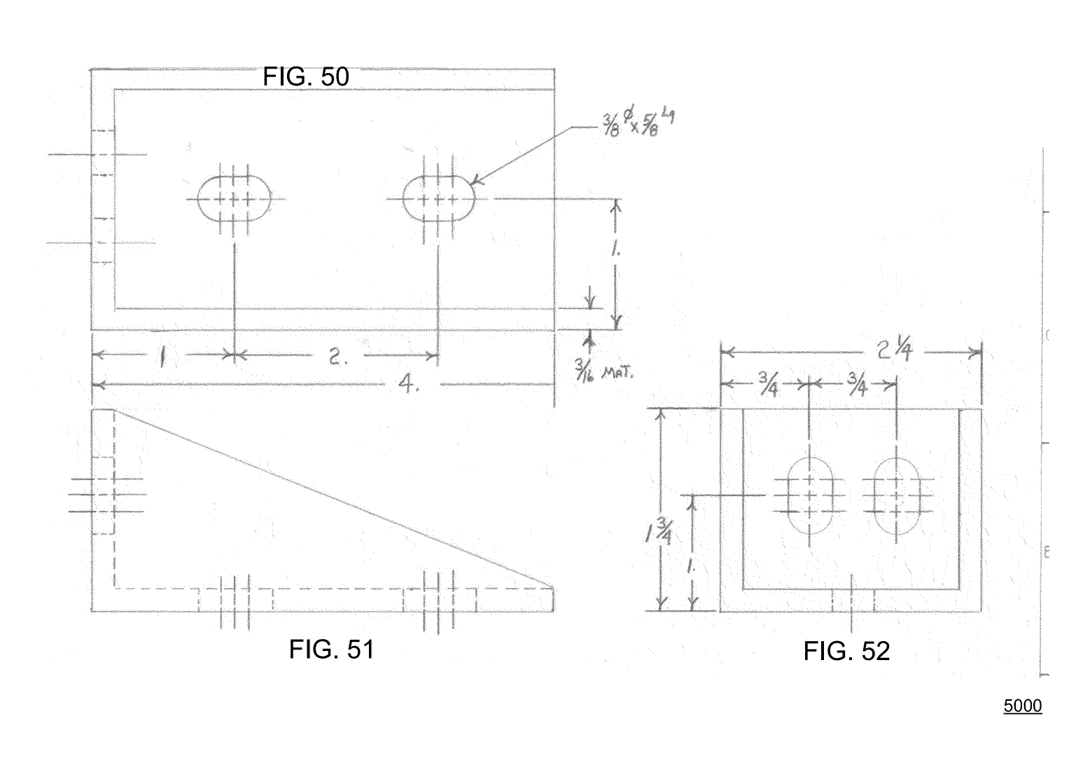

FIG. 50 is a block diagram of a top view of a gusset, according to an implementation, which is located in the small end cap 140 in FIG. 1.

FIG. 51 is a block diagram of a side view of the gusset, according to an implementation, which is located in the small end cap 140 in FIG. 1.

FIG. 52 is a block diagram of a side view of the gusset, according to an implementation, which is located in the small end cap 140 in FIG. 1.

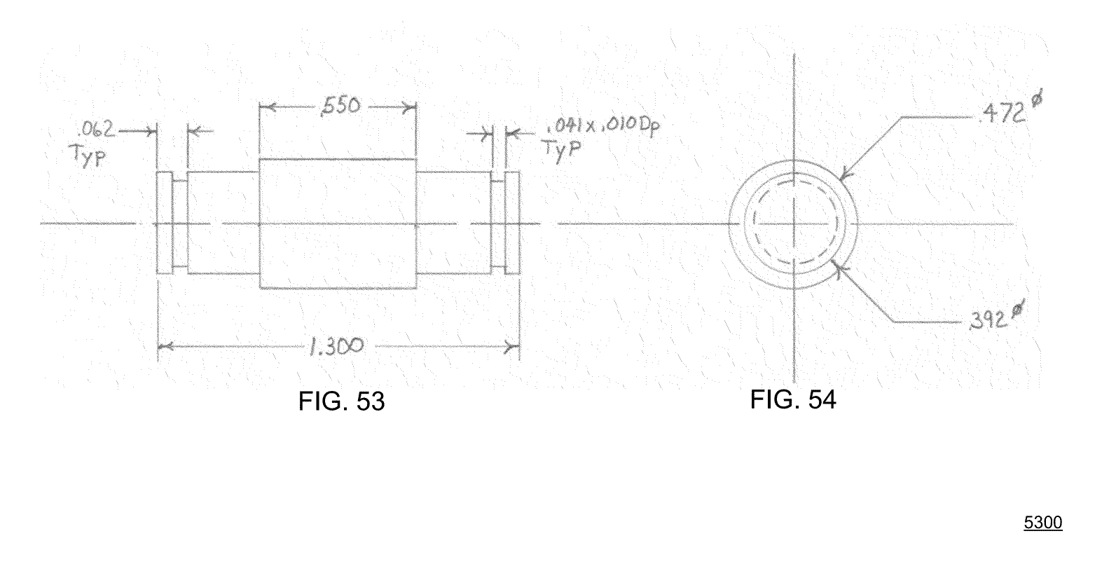

FIG. 53 is a block diagram of a side view of a trolley shaft, according to an implementation.

FIG. 54 is a block diagram of a top view of the trolley shaft, according to an implementation.

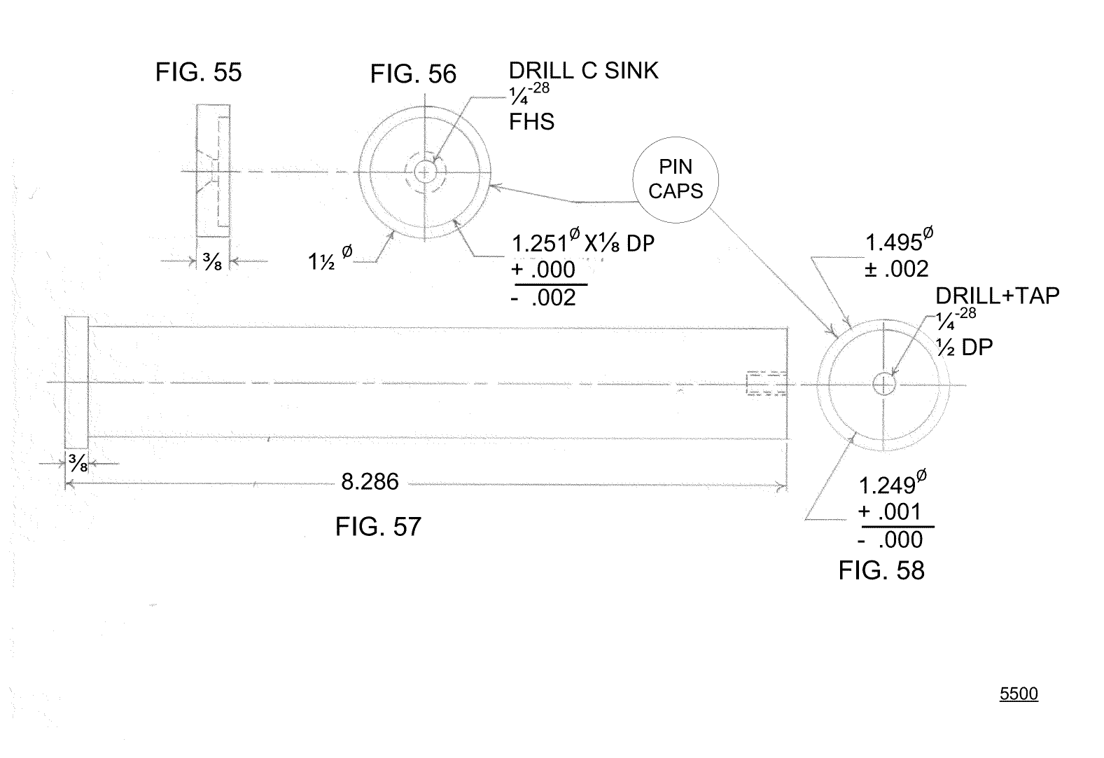

FIG. 55 is a block diagram of a side view of a pin assembly, according to an implementation.

FIG. 56 is a block diagram of a top view of the pin assembly according to an implementation.

FIG. 57 is a block diagram of a side view of the pin assembly, according to an implementation.

FIG. 58 is a block diagram of a bottom view of the pin assembly according to an implementation.

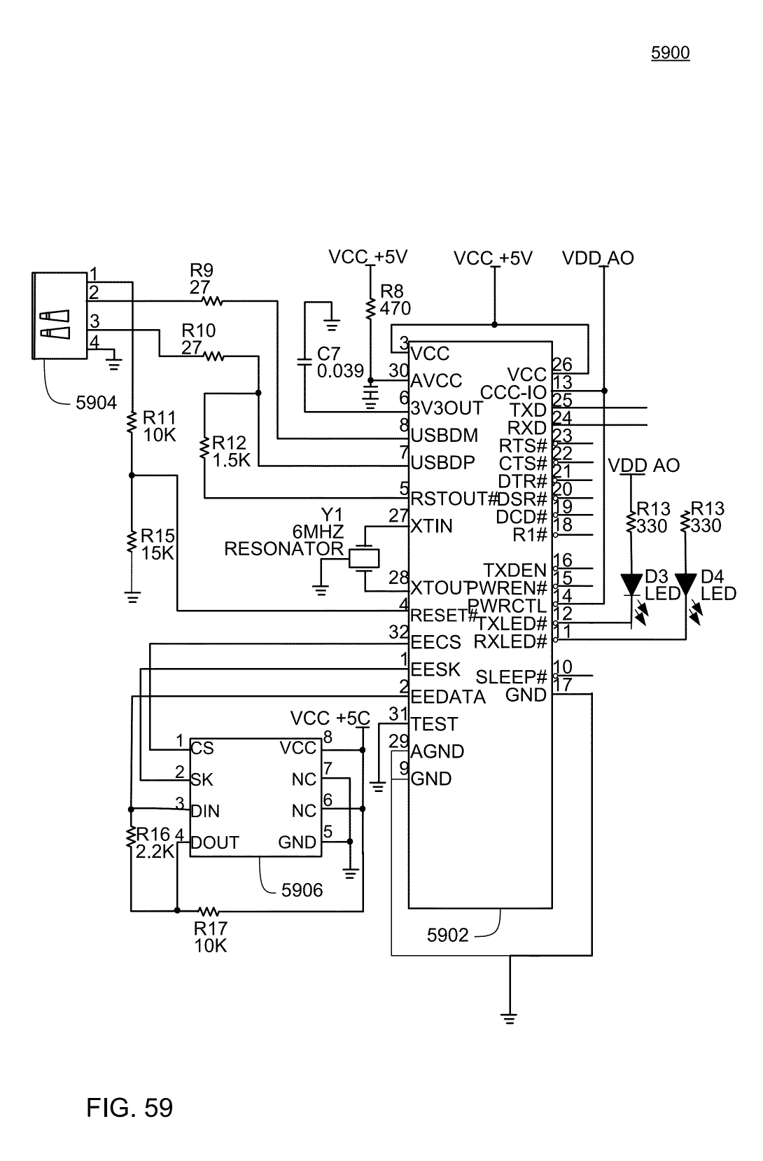

FIG. 59 is an electrical schematic diagram of a patient lift control apparatus 5900 to control a patient lift, according to an implementation. The patient lift control apparatus 5900 receives input from any one of a number of input mediums, including audio, and therefrom controls a patient lift. The patient lift control apparatus 5900 can fit inside the housing of conventional patient lift and can communicate with and control the conventional patient lift using the conventional existing electrical circuitry of patient lift. The patient lift control apparatus 5900 helps improve control of the patient lift by receiving input from any one of a number of input mediums, including audio. In the example of audio, the patient lift control apparatus 5900 improves the ease and convenience with which an operator can control the patient lift by providing mechanized control of the patient lift. In general, the patient lift control apparatus 5900 improves the ease and convenience with which an operator can control the patient lift by providing a command interface by a handheld control device, such as the hand-held keypad controller 132 in FIG. 1

Patient lift control apparatus 5900 includes a microcontroller, processor or microprocessor 5902, such as a RSC 6502 microcontroller. The microcontroller, processor or microprocessor 5902 includes non-volatile memory (not shown) such as Flash memory that can be electrically erased and reprogrammed. The RSC 6502 microcontroller is merely one example of a microcontroller, processor or microprocessor that can be used in the patient lift control apparatus 5900. The RSC 6502 microcontroller has been manufactured by Conexant Systems at 4000 MacArthur Boulevard, Newport Beach, Calif.

The microcontroller, processor or microprocessor 5902 is operably coupled to at least one input device (not shown), such as one of the devices shown in FIG. 5 including a keyboard, a synaptic reader, and/or a microphone. And some implementations, the microcontroller, processor or microprocessor 5902 is operably coupled to a program/run switch (not shown) that is set to indicate the mode that the microcontroller, processor or microprocessor 5902 is operating.

In some implementations, the microcontroller, processor or microprocessor 5902 is operably coupled to another memory (not shown) that stores data and programs. In some implementations, the microcontroller, processor or microprocessor 5902 is operably coupled to a digital-to-analog (DAC) converter that generates DAC output (not shown). In some implementations, the microcontroller, processor or microprocessor 5902 is operably coupled to an audio speaker (not shown).

In some implementations, the microprocessor/microcontroller/processor incorporates infrared (IR) and radio frequency (RF) wireless protocols including Zigbee and Bluetooth wireless protocols with positional awareness and a complex programmable logic device (CPLD) interface. The microprocessor/microcontroller/processor communicates with and controls multi-sensory controls for products from microwaves and washing machines to spacecraft. The microprocessor/microcontroller/processor is selected from both 16-bit and 32-bit devices. The microprocessor/microcontroller/processor having 16-bit radio-frequency (RF) interfaces are well-suited for applications such as wireless keyboard/mouse, wireless voice-over-IP (VoIP), remote controls, wireless gaming accessories, home and building automation applications such as alarm and security systems, automatic meter reading systems, active radio-frequency identification (RFID) systems and other monitoring and control systems. Microprocessor/microcontroller/processors having 32-bit word-length include high performance integrated peripherals designed for real-time control applications. An optimized core of the microprocessor/microcontroller/processor performs multiple complex control algorithms at speeds necessary for demanding control applications. Integrated peripherals such as a 16-channel, 12-bit analog-to-digital conversion (ADC) running at up to 12.5 megasamples per second and high resolution pulse-width modulation (PWM) modules with 150 picosecond resolution provide sufficient bandwidth for communication with analog devices. Further including the serial peripheral interface (SPI), universal asynchronous receiver/transmitter (UART), inter-IC (I2C), campus area network (CAN), and multi-channel buffered serial port (McBSP) communication peripherals provides device control on a single microprocessor/microcontroller/processor. Applications include appliances, alternating current/direct current (AC/DC), direct current/alternating (DC/AC) and direct current/direct current (DC/DC) digital power supplies, solar inverters, digital motor control, and power line communication.

The microcontroller, processor or microprocessor 5902 is operably coupled to the control box 128. The patient lift controller 5900 is electrically coupled to at least one patient lift, such as 100 in FIG. 1. Patient lift controller 5900 is one implementation of the patient lift controller 5900 for a two dimensional patient lift, that implements a double-pole-double-throw (DPDT) relay for each direction of movement of the two dimensional patient lift.

In some implementations, the microcontroller, processor or microprocessor 5902 is operably coupled to a serial port 5904 through which program instructions can be loaded onto the microcontroller, processor or microprocessor 5902.

In some implementations, the microcontroller, processor or microprocessor 5902 is operably coupled to a nonvolatile memory that stores a patient lift control engine. In the implementation shown in FIG. 59, the nonvolatile memory is electrically erasable programmable read only memory (EEPROM) 5906. The patient lift control engine 5906 includes a predefined set of functions that are called during patient lift control operations.

### Method Implementations

In the previous section, apparatus of the operation of an implementation was described. In this section, the particular methods performed by a human of such an implementation are described by reference to a series of flowcharts.

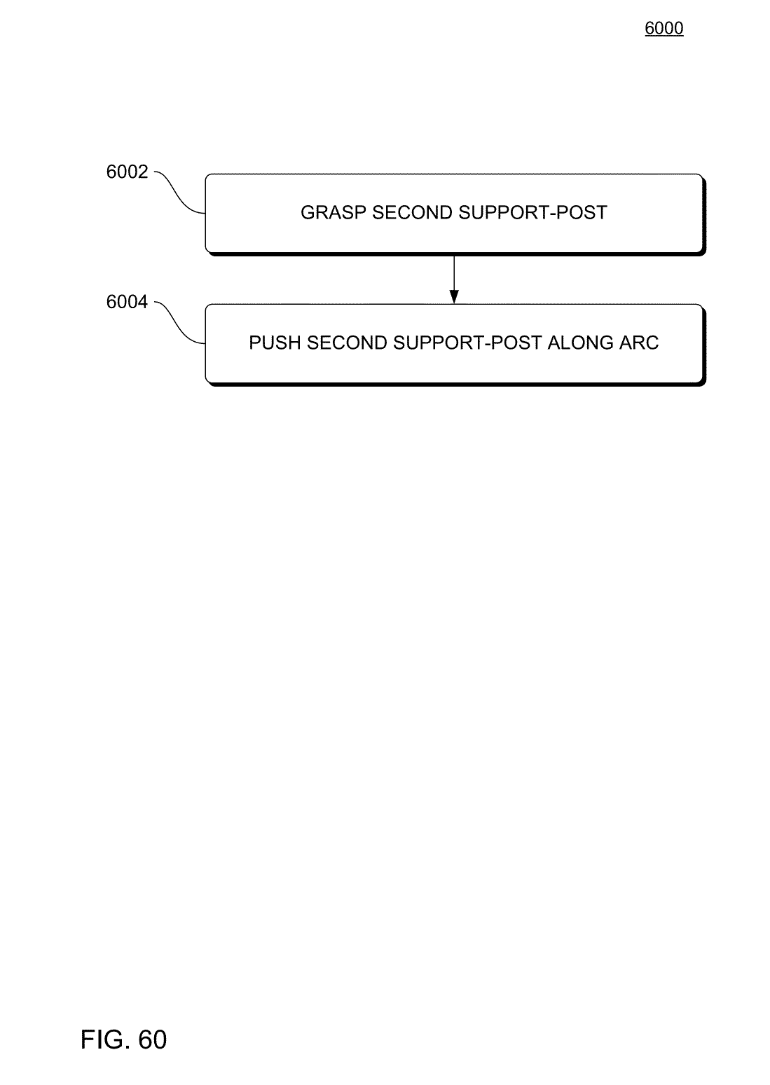

FIG. 60 is a flowchart of a method 6000 to operate a patient with an articulating section, according to an implementation.

Method 6000 includes grasping a second support-post 138, at block 6002, and thereafter pushing the second support-post along the arc 202, at block 6004.

### CONCLUSION

A patient lift swivel is described. Although specific implementations are illustrated and described herein, it will be appreciated by those of ordinary skill in the art that any arrangement which is calculated to achieve the same purpose may be substituted for the specific implementations shown. This disclosure is intended to cover any adaptations or variations.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future patient lift devices, different gantries, and new materials.

The terminology used in this application is meant to include all patient lifts and medical environments and alternate technologies which provide the same functionality as described herein.

1. An apparatus to move a patient, the apparatus comprising:
a plurality of wheels;
a first support-post fixedly attached to the wheels, the first support-post being indirectly fixedly attached to the wheels;
a swivel mechanism having two ends, a first end of the two ends being fixedly attached to the first support-post, the first end of the two ends of the swivel mechanism being indirectly fixedly attached to the first support-post;
a large end cap being fixedly attached to a second end of the two ends;
another wheel fixedly attached to the large end cap; and
a patient lift gantry attached to the large end cap.

2. The apparatus of claim 1, wherein the apparatus further comprises:
a second support-post fixedly attached to the large end cap and the other wheel.

3. The apparatus of claim 1, wherein the apparatus further comprises:
the first support-post being directly fixedly attached to the wheels.

4. The apparatus of claim 1, wherein the apparatus further comprises:
the large end cap being directly fixedly attached to the second end of the two ends.

5. The apparatus of claim 1, wherein the apparatus further comprises:
the large end cap being indirectly fixedly attached to the second end of the two ends.

6. An apparatus to move a patient, the apparatus comprising:
a plurality of wheels;
a first support-post fixedly attached to the wheels;
a swivel mechanism having two ends, a first end of the two ends being fixedly attached to the first support-post;
a large end cap being fixedly attached to a second end of the two ends; and
a patient lift gantry attached to the large end cap.

7. The apparatus of claim 6, wherein the apparatus further comprises:
another wheel fixedly attached to the large end cap.

8. The apparatus of claim 7, wherein the apparatus further comprises:
a second support-post fixedly attached to the large end cap and the other wheel.

9. The apparatus of claim 6, wherein the apparatus further comprises:
the first support-post being directly fixedly attached to the wheels.

10. The apparatus of claim 6, wherein the apparatus further comprises:
the first support-post being indirectly fixedly attached to the wheels.

11. The apparatus of claim 6, wherein the apparatus further comprises:
the large end cap being directly fixedly attached to the second end of the two ends.

12. The apparatus of claim 6, wherein the apparatus further comprises:
the large end cap being indirectly fixedly attached to the second end of the two ends.

13. The apparatus of claim 6, wherein the apparatus further comprises:
the first end of the two ends of the swivel mechanism being directly fixedly attached to the first support-post.

14. An apparatus to move a patient, the apparatus comprising:
a plurality of wheels;
a first support-post fixedly attached to the wheels;
a swivel mechanism having two ends, a first end of the two ends being fixedly attached to the first support-post;
a pivoting member being fixedly attached to a second end of the two ends; and
a patient lift gantry attached to the pivoting member.

15. The apparatus of claim 14, wherein the apparatus further comprises:
another wheel fixedly attached to the pivoting member.

16. The apparatus of claim 15, wherein the apparatus further comprises:
a second support-post fixedly attached to the pivoting member and the other wheel.

17. The apparatus of claim 14, wherein the apparatus further comprises:
the first support-post being directly fixedly attached to the wheels.

18. The apparatus of claim 14, wherein the apparatus further comprises:
the first support-post being indirectly fixedly attached to the wheels.

19. The apparatus of claim 14, wherein the apparatus further comprises:
the pivoting member being directly fixedly attached to the second end of the two ends.
